(19) United States
(12) Patent Application Publication
(10) Pub. No.: US 2011/0233014 A1
(43) Pub. Date: Sep. 29, 2011

(54) SUSPENSION SYSTEM WITH PROGRESSIVELY CONSTRICTING PLUNGER

(76) Inventor: Nick Horlock, Halls Head (AU)

(21) Appl. No.: 12/863,426

(22) PCT Filed: Jan. 17, 2008
(86) PCT No.: PCT/AU2008/000062

§ 371 Date: Jun. 21, 2011

(51) Int. Cl. F16F 9/48; F16F 9/06

(52) U.S. Cl. 188/287; 188/284; 188/286

(57) ABSTRACT

A suspension apparatus for providing a progressively dampened motion, said apparatus comprising a housing (14) defining a first chamber (12) having a first end (26) with said first chamber (12) containing a volume of liquid (52). The apparatus further comprises at least one plunger (6) defining a second chamber (8) with the plunger (6) being slidably movable within said housing (14) and containing a volume of gas (56). A fluid communication path (80) provides for fluid communication between the first and second chambers allowing the transferal of liquid (52) between the first and second chambers. Transfer of liquid (52) into the second chamber (8) compresses the gas (56) whereby the fluid communication path (80) becomes progressively constricted as the plunger (6) is motivated toward said first end (26) of said first chamber (12) by a load applied or transmitted to said plunger (6).

### FIELD OF THE INVENTION

The present invention relates to a suspension apparatus.

### BACKGROUND OF THE INVENTION

Force dampening systems or suspension units are used in many fields of engineering and construction for damping force induced motion. Examples of such use include use in vehicles to couple wheels to a vehicle chassis and in prime movers for attaching seats to a floor. Known suspension units often comprise mechanical (steel) springs and/or hydraulic shock absorbers.

The suspension unit described herein may be used in any field of engineering, construction and transport in which prior art suspension units are currently used.

It is to be understood that, if any prior art publication is referred to herein, such reference does not constitute an admission that the publication forms a part of the common general knowledge in the art, in Australia or any other country.

### SUMMARY OF THE INVENTION

In the claims and description of the invention, except where the context requires otherwise due to express language or necessary implication, the words “comprise” or variations such as “comprises” or “comprising” are used in an inclusive sense, i.e., to specify the presence of the stated features but not to preclude the presence or addition of further features in various embodiments of the invention.

In a first aspect of the present invention there is provided a suspension apparatus for providing a progressively dampened motion, said apparatus comprising:

a housing defining a first chamber and having a first end, said first chamber containing a volume of liquid;

a plunger defining a second chamber, said plunger movable within said housing and containing a volume of gas; and,

a fluid communication path between the first and second chambers, wherein movement of said plunger within said housing causes transfer of liquid between said first and second chambers;

wherein said gas is compressed by flow of said liquid into said second chamber;

wherein said fluid communication path becomes progressively constricted as said plunger is moved toward said first end of said first chamber.

In an embodiment of the present invention the fluid communication path comprises at least one aperture through which the liquid passes when flowing from the first chamber to the second chamber and the at least one aperture becomes progressively obstructed as the plunger moves toward the first end. A further embodiment can be realised wherein the plunger slides along at least one guide disposed within said housing. In an embodiment the guide extends from the first end. Furthermore, the guide may define a third chamber that is in fluid communication with the second chamber and wherein the at least one aperture is formed within the guide providing fluid communication between the first and second chambers. A further embodiment may comprise a plurality of apertures that are progressively obstructed as the plunger moves toward the first end of the first chamber.

An alternative form of the current embodiment may comprise the at least one aperture comprising a gap between the plunger and the guide. The gap may comprise a space formed between an opening in the plunger and an outer surface portion of the guide received in the opening. The outer surface portion of the guide may also have a varied cross sectional perimeter along the length of the guide. The varied cross sectional perimeter of the guide may increase along the length of the guide toward an end proximal the first end. It may also be appreciated that the cross sectional perimeter of the opening within the plunger, through which said guide is received, is varied along the length of the opening. In the previous embodiments described the guide may comprise a stem concentric with a central axis of the first chamber. Furthermore, the plunger may also be concentric with the central axis of the first chamber.

In a second aspect of the present invention there is provided a suspension apparatus for providing a progressively dampened motion, said apparatus comprising:

a housing defining a first chamber having a first end, said first chamber containing a volume of liquid;

at least one plunger defining a second chamber containing a volume of gas, said plunger movable within said housing; and,

a stem defining a third chamber which is in fluid communication with said second chamber, said stem having at least one aperture permitting fluid communication between said first and third chambers whereby liquid is transferred between said first chamber and second chamber via said third chamber so as to compress said gas and said at least one aperture becomes progressively obstructed when said plunger is moved toward said first end of the first chamber.

In accordance with the second aspect of the present invention the stem is formed with a cross section that is generally uniform. The stem extends from the first end of the housing. It may further be recognized that a distal end of the plunger may also be of a uniform cross section. Furthermore, a plunging portion of the plunger may be of a dimension that is greater than the distal end of the plunger. In a further embodiment the stem and the plunger are concentric with a central axis of the first chamber.

In an embodiment the stem comprise a plurality of apertures and wherein each of the apertures is located within a single cross sectional plane through the stem. In one form of the at least one aperture comprises a slot having a portion that extends along the length of said stem.

In a third aspect of the present invention there is provided a suspension apparatus for providing a progressively dampened motion, said apparatus comprising;

a housing defining a first chamber having a first end, said first chamber containing a volume of liquid;

at least one plunger defining a second chamber containing a volume of gas, said plunger movable within said housing; and,

a stem configured in such a manner so as to define in combination with said plunger a progressive constriction of a fluid flow path through which liquid flows from said first chamber into said second chamber so as to compress said gas when said plunger is moved towards said first end of the first chamber.

In accordance with the third aspect of the present invention the stem extends from said first end and is tapered in a direction toward a distal end of the stem. Further, an inwardly facing surface of said plunger opposite said taper of said stem may be configured so that said progressive constriction is greatest when said plunger is nearer the first end of the first chamber. In an embodiment the stem defines a third chamber in fluid communication with said second chamber providing fluid communication through at least one aperture that may be axially or radially spaced within said stem, to permit transfer of liquid from the first chamber to the second chamber.

The at least one aperture may comprise a plurality of apertures of the same dimension or a plurality of apertures of different dimensions. Furthermore, at least one of said aperture(s) may be configured to offer a variable dimension to regulate liquid or fluid transfer accordingly. It may be further realised that the variability could be either automatic or manual effected by a control system or manual adjustment means. The variability of the aperture dimension may be influenced by the required dampening rate or regulated by a specific passive or active control system monitoring the applied loads and liquid transfer rate while the plunger is operable.

Applicable to each of the aspects of the present invention described above is a base of said housing that is rigidly mounted to a load bearing structure. Further, the load bearing structure may comprise a chassis or floor of a marine craft. Furthermore, a body, that is to be isolated from any external or any transmitted forces, may be rigidly mounted to the plunger. It may be readily appreciated that such a body may comprise a chair, seat or similar item.

Applicable to each of the aspects of the present invention described above is the use of at least one sealing means that is provided within at least one aperture of said housing into which said plunger is slidingly engaged.

Applicable also to each of the aspects of the present invention described above is where the plunger may be configured with an air valve into which a compressor or like means may be connected into so as to increase the pressure of said volume of gas.

### BRIEF DESCRIPTION OF THE DRAWINGS

Embodiments of the present invention will now be described, by way of example only, with reference to the accompanying drawings, in which;

FIG. 1 shows a diagrammatic representation of one embodiment of the present invention when in a first condition,

FIG. 2 shows a diagrammatic representation of the embodiment of the present invention shown in FIG. 1 when biased under the application of an external load,

FIG. 3 shows a diagrammatic representation of the embodiment of the present invention shown in FIG. 1 when returning to the first condition,

FIG. 4 shows a diagrammatic representation of a further embodiment of the present invention when biased under the application of an external load,

FIG. 5 shows a diagrammatic representation of the embodiment of the present invention shown in FIG. 4 when returning to a condition prior to application of the external load,

FIG. 6 shows a diagrammatic representation of the present invention when adapted to include an air port or valve,

FIG. 7 shows a diagrammatic representation of an example implementation of the present invention when used to dampen the motion of a seat or chair.

### DETAILED DESCRIPTION

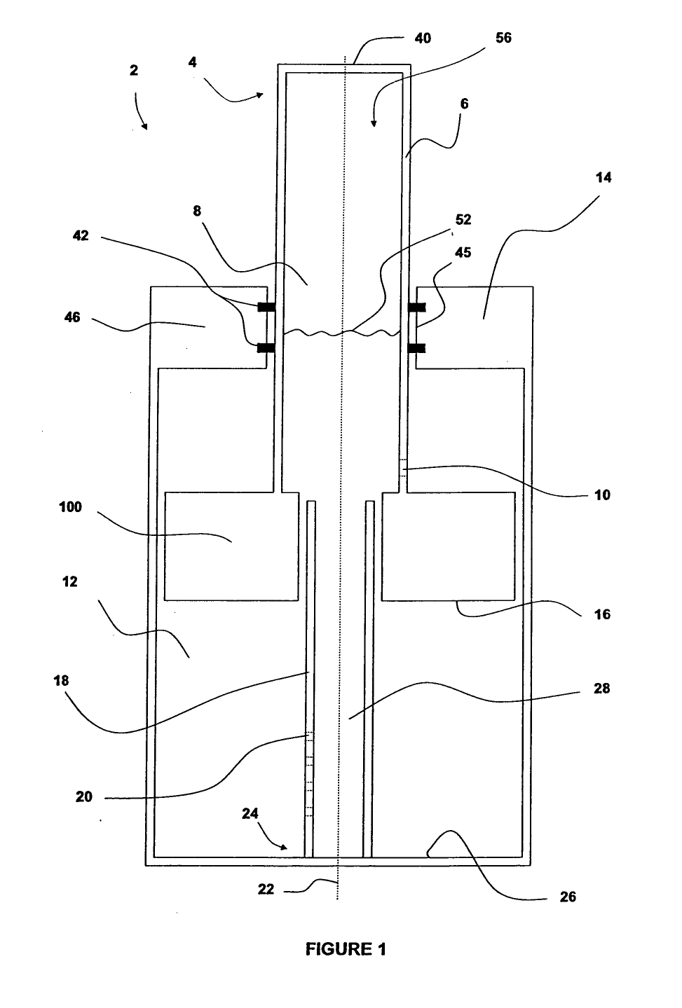

A first embodiment of the present invention is shown in FIG. 1 where a suspension apparatus (2) is shown in an initial, or first condition, prior to experiencing a bias from an externally applied load. The suspension apparatus (2) of the embodiment considered comprises a housing (14) defining a first chamber (12) and a first end (26). The first chamber (12) contains or holds a volume of liquid (52) which can be selected from any number of non-compressible fluids suitable for use in hydraulic applications.

Within the housing (14) there is provided at least one plunger (6) which additionally defines a second chamber (8). The plunger (6) is configured in such a manner so as to be telescopically movable within the housing (14) while containing a volume of gas (56) within a distal end (4). In order to achieve a low co-efficient of friction, while maintaining an adequate hydraulic seal between the plunger (6) and the housing (14), seal rings (42) are located within the inwardly facing surface of an aperture (45) within in a neck portion (46) of housing (14). Use of the sealing rings (42) allows the plunger (6) adequate movement to affect the required stroke or displacement when in operation. It will be appreciated that other means may be included to provide an adequate sealing yet reduced friction effect.

For the current embodiment considered, FIG. 1 shows plunger (6) and housing (14) in a concentric relationship about a central axis (22). The housing (14) is generally of a cylindrical nature as is the plunger (6). The apparatus (2) depicted is longer than its width, but it will be appreciated that the cylinder's width may be larger than the cylinder length. The distal end (4) of the plunger (6) may have a uniform cross section with a plunging portion (100) being of a dimension that is at least that of the distal end (4) or greater. FIG. 1 shows plunging portion (100) in the form of a plunger head being of a uniform dimension greater than that of the distal end (4) of plunger (6). It would be readily understood to those skilled in the art that said plunger (6) and housing (14) may be configured in such a way that is not of a concentric design nor is reliant upon a symmetric relationship.

For the current embodiment shown in FIG. 1, a fluid communication path is established to allow the liquid (52) to flow between the first (12) and second chambers (8). Liquid (52) can be transferred between first (12) and second chambers (8) by at least one aperture (20) located within a guide or stem (18) about which the plunger (6) is slidingly engaged. The guide or stem (18) defines an additional (third) chamber (28) also in fluid communication with the second chamber (8) via an opening at the top of the guide or stem (18). The fluid communication path from the first chamber (26) to said second chamber (8) is therefore by virtue of the third chamber (28) and through the apertures (20). The currently described embodiment of the present invention employs four apertures (20) within the guide or stem (18) to allow transfer of the liquid (52) between said first and third chambers. The guide or stem (18) is shown in FIG. 1 to be generally cylindrical with a uniform cross section and extends from the first end (26) about the central axis 22. It will be understood that embodiments may be realized where the guide or stem (18) comprises other forms that retain a sliding engagement with the plunger (6) and do not rely on concentricity with the central axis (22) of the housing (14).

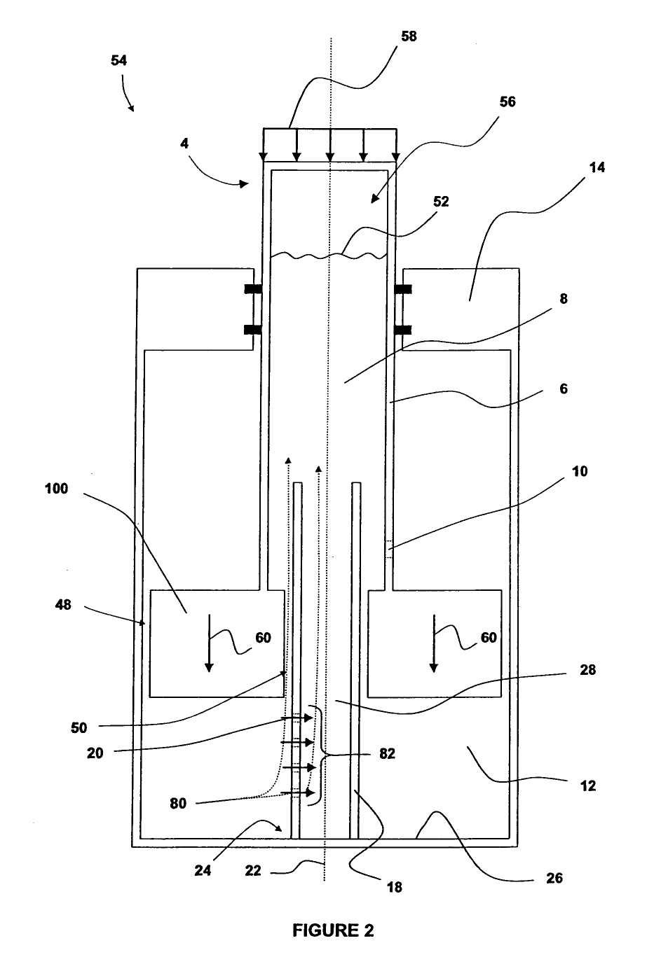

The transfer of fluid can be described by considering FIG. 2 which shows the configuration of the current embodiment of the present invention now engaged in a plunging operation (54). The plunging operation (54) is characterized by the plunger (6) being moved toward the first end (26) by the application of an external load (58) acting on the external face (40) of the distal end (4) of the plunger (6) with respect to the housing (14). Such movement is indicated in FIG. 2 by arrows (60). The transmission of the external loads to the distal end (4) of plunger (6) is due to the housing (14) being fastened rigidly to a structure or chassis of a load bearing component that is itself subject to external forces. Movement of the plunger (6) in the direction (60) will result in a flow or transfer of liquid (in a direction (82)) through the aperture(s) (20) from the first chamber (12) into the third chamber (28) and subsequently into the second chamber (8). It will be appreciated that as the plunger (6) moves toward the first end (26), sequential aperture(s) (20) becomes obstructed thus progressively constricting the flow or transfer of liquid. Generally, each aperture(s) (20) will become obstructed by the plunging portion (100) as the movement progresses towards the first end (26).

Liquid transfer may also be partly established by virtue of a first clearance (48) and a second clearance (50) denoting the respective dimension between the external surface of plunger (6) and the internal wall of the first chamber (12) (clearance (48)) and the surfaces of said plunger that are proximal to the guide or stem (18) when slidingly engaged (clearance (50)). Fluid passing through clearance (50) may contribute to the body of fluid entering the second chamber (8), however, fluid passing through clearance (48) will enter a portion of the first chamber (12) that is separated from the second chamber (8) by the walls of the plunger (6). Therefore, liquid passing through clearance (48) will affect to reduce the reactive load experienced by the plunger (6) and provide an alternate leak path for the liquid during a plunging operation (54). Clearances (48) and (50) are configured in the current embodiment to permit a limited amount of fluid flow to allow at least a lubricating effect to be established to reduce friction between the outer surfaces of plunger (6) with the walls of the first chamber (12) and those of the guide or stem (18). In respect of the presently described embodiment, clearances (48) and (50) would most likely be described by those skilled in the art as being of a “neat” or “snug” fit dimension.

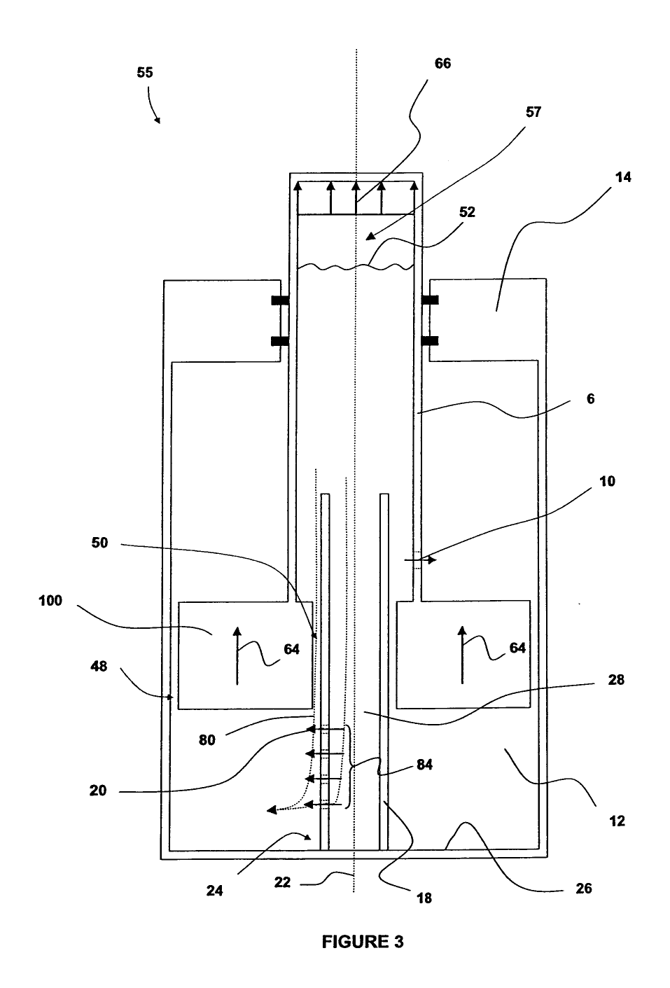

The plunging motion of plunger (6), as shown in FIG. 2, will continue until the liquid (52) and the compressed gas (shown in FIG. 3) within distal end (4) reach an equilibrium point wherein the force exerted by the compressed gas state, upon the liquid, equates to the magnitude of the external load (58). Therefore, the motion of the plunger (6) will reach a point where additional movement is restricted due to the occurrence of what is known in the art as a “hydraulic lock”. A “hydraulic lock” is achieved when the gas (56) is compressed (57) to a point where a balance between the pressure exerted by the compressed gas (57) upon the liquid equates with the applied load (58) and results in a force balance equilibrium. Until this point is reached, the motion of plunger (6), due to the applied load (58), will be progressively reduced or dampened by virtue of the controlled rate of liquid transfer through the apertures (20) to the second chamber (8) to create the compressed gas state (57).

Once the plunger (6) has ceased to move due to the “hydraulic lock” equilibrium point being reached, removal of the applied load (58) will permit the plunger (6) to begin to return to the first state shown in FIG. 1. FIG. 3 presents this return operation (55) showing the internal reaction load (66) caused by the compressed gas (57) expanding from its compressed state due to removal of the applied load (58) and perturbing the force equilibrium point. As shown, the direction of the plunger reverses (64) and fluid transfer is now encouraged in a direction (84) back through the aperture holes (20). Liquid now flows from the second chamber (8) into the first chamber (26) via the third chamber (28). It will be realized that as the plunger (6) gains momentum during the return stroke toward the initial, or first state, the movement will effectively create a negative relative pressure below the plunger (6) producing a vacuum effect that urges liquid through the aperture(s) holes (20) in accordance with direction (84).

A feature influencing the rate of fluid flow between the first chamber (26) and second chamber (8) is the dimension of the aperture holes (20) within the stem portion (18). It would be readily evident that the number and dimension of the aperture holes (20) will greatly influence the transfer of fluid in either forward (plunging (54)) or return (55) operations thus influencing the characteristic rate of the progressive damping motion of the plunger (6) in response to the external load (58). Depending upon the application into which the current embodiment of the present invention is employed, the stem portion (18) may be fabricated with any number of apertures with each aperture being either of the same dimension or of differing dimensions. In particular the number of apertures may vary along the length of the guide or stem (18). In some embodiments of the present invention such apertures (20) may comprise a slot or similar type opening that may be facilitate the flow or transfer of liquid between chambers. The slot could be aligned radially or axially along the length of the guide or stem (18). In such instances, progressive constriction of the flow would occur as the plunger (6) progressively obstructs the opening (thus reducing the fluid communication pathway) and limiting the transfer of liquid. The placement or location of the aperture(s) within the guide or stem (18) may also be axially along the length of the guide or stem (18) or spaced radially within a single cross sectional plane or comprise a combination of both placement types. The latter being partly or wholly dependant upon the flow rate or characteristics dampening rate required for the given application.

Another embodiment of the present invention may be realised in that a plurality of guide or stem (18) may exist within a housing (14) with a plurality of complementary plungers (6). Particular loading applications may require specific effective progressive dampening motions that may be facilitated by more than one guide or stem (14)/plunger (6) combination existing within a first chamber (12) of a housing (14). For such a configuration, the workings of the previously described embodiments would remain the same with there being a plurality of plunger/stems operating in unison, in parallel or in series. It will be readily appreciated that the load transmission and application to each distal end (4) of each plunger (6) will be by way of an appropriate mechanical load transmission means. Such may involve a plate or the like rigidly joining all distal ends (4) together to ensure all plungers work or operate in unison when subject to external loading. It may be further realized that the load transmission component may be adapted or configured in such a way so as to align different plungers (6) at different initial displacements so as to have different first states depending upon the characteristic of the dampened motion required for the particular application. Therefore, the rate of fluid flow, and thus the resulting dampened motion achieved, will be influenced by where each contributing plunger element is placed relative to the associated apertures (20) prior to a plunging motion beginning. Such an embodiment may have useful benefits when used to provide a damping means for high load applications where specific progressive dampening rates are required.

It may further be realised that a mechanism could be included within the previously described embodiments to provide a means of actively controlling the size of a single aperture hole or a plurality of aperture holes (20). Such a mechanism could then adjust or vary the size of the aperture(s) in accordance with the applied load or required dampening thus altering the fluid transfer rate and changing the characteristic damping rate. A system could be realized whereby the applied loads, liquid transfer rate and motion characteristics (velocity, acceleration and displacement) of the plunger (6) are monitored during the plunging operation allowing the computation of the associated dampening rate. The computed dampening rate could be compared to the required or desired dampening rate in order to determine whether or not the aperture dimension should be altered. Such a system could also be employed to selectively close some of the apertures to vary the dampening rate.

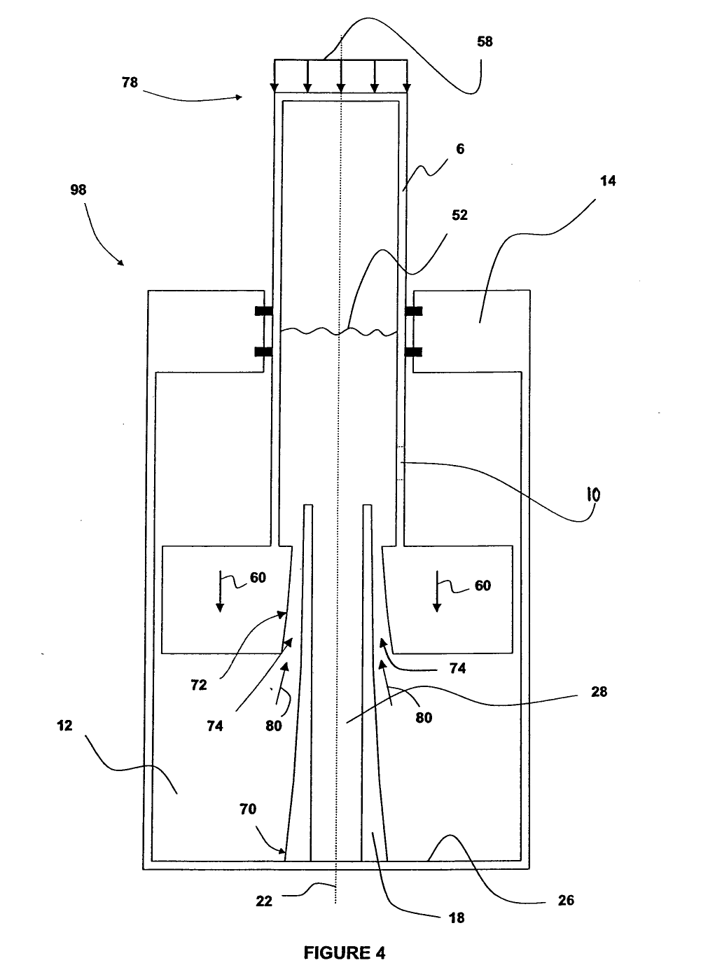

A further embodiment (98) of the present invention is shown in FIG. 4. FIG. 4 shows a similar embodiment as previously described (shown in FIGS. 1 through 3), however, with the notable omission of the apertures (20) from the guide or stem (18). The plunger (6) is shown responding to an applied load (58) in a direction (60) toward the first end (26) of the housing (14). For this embodiment, an internal facing wall (72) of the plunger (6) is configured so that when plunger (6) is motivated towards the first end (26), a fluid communication path bounded between an external surface (70) of the guide or stem (18) and the inner facing wall (72) is perturbed changing the effective clearance through which liquid may flow thus altering the rate at which liquid is transferred between the first chamber (26) and the second chamber (8). Therefore, the momentary gap or clearance established between the inner facing wall (72) and the external wall (72) influences the liquid transfer rate and the resulting dampening motion. The change in the outer dimension of the external surface (70) along the length of the stem (18) toward the first end (26) will alter the geometry of the fluid communication path for a given configuration of the inner facing wall (72) of the plunger (6). It may be appreciated that any non-uniform geometry that changes the cross sectional perimeter of the external surface (70) of the guide or stem (18) may be applied to the embodiments described herein depending upon the dampening motion required for the given application. By way of example, a sinusoidal geometry may be applied to external surface (70) such that, when plunger (6) is operable in a plunging operation, the apparatus of the current embodiment provides a unique dampening motion. Similarly, the inner facing surface (72) may also be of a non-uniform or variable cross sectional in which the cross sectional perimeter alters as a function of the length of the plunger (6).

FIG. 4 further shows the guide or stem (18) having a tapered outer surface where the taper extends toward an end of guide or stem (18) that is distal to the first end (26) of the housing (14). As the plunger (6) nears the first end (26), the gap or clearance (74) between the tapered surface (70) and the inner facing surface (72) becomes constricted, further restricting the rate of transfer of liquid thus resulting in a progressive dampening motion in response to external load (58). Therefore, due to the omission of apertures (20) of the previous embodiment, liquid transferred between the first chamber (26) and the third chamber (28) is now affected by a fluid transfer path (80) and influenced by the interaction of the proximal surfaces of guide or stem (18) and the plunger (6). The current embodiment therefore requires no need for a third chamber (28). It would be appreciated, however, that inclusion of a third chamber (28) will not adversely affect the operation of the suspension apparatus of the currently described embodiment. The current embodiment may further operate with the guide or stem (18) having at least one aperture or slot, axially or radially located, to facilitate the liquid transfer rate.

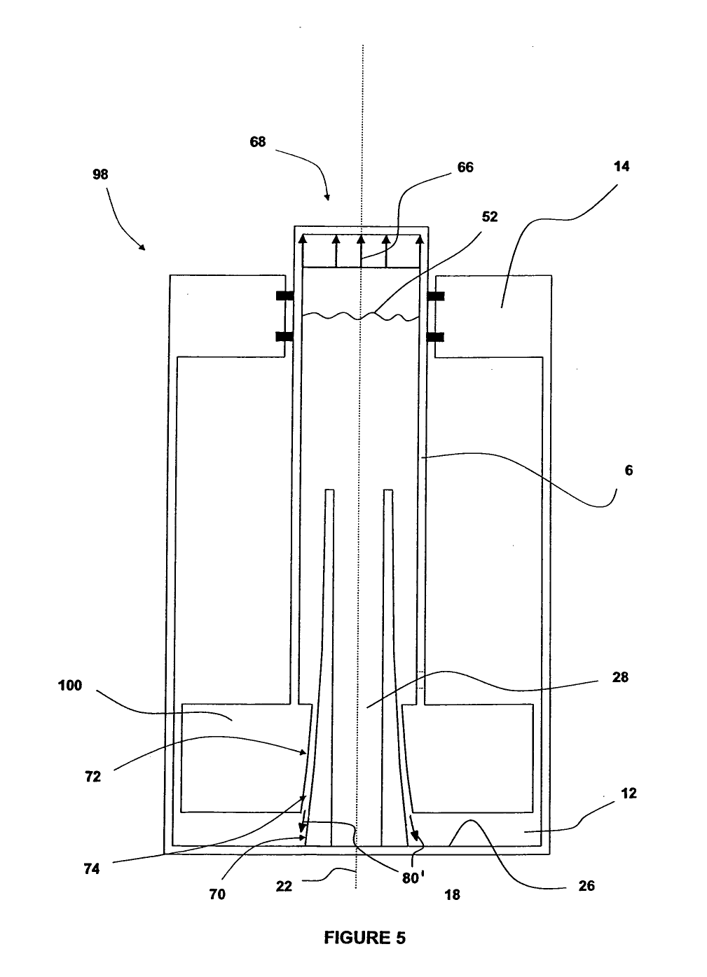

FIG. 5 shows the situation of the current embodiment of the present invention wherein plunger (6) has lowered sufficiently to reach a “hydraulic lock” position and is soon to begin the return stroke toward the first state. As the plunger (6) is biased toward the first state, fluid transfers (or leaks) from the second chamber (8) to the first chamber (12) in a reverse flow direction 80′ of the liquid communication path shown in FIG. 4. It may be appreciated that a similar relative negative pressure environment will develop below the plunger (6) when engaged in the return stroke. The effect of the negative pressure therefore creates a suction force that encourages fluid into the first chamber (12) by the movement of the plunger (6).

Fluid transfer between the second chamber (8) and the first chamber (12) may be assisted by the presence of a top fluid port (10) of FIGS. 1 to 3 within the wall of plunger (6). It would be readily appreciated that the dimension and number of top fluid port holes (10) used can be varied depending upon the application in which the apparatus of either embodiment of the present invention is used as well as the type of dampening motion required. Furthermore, it may also be appreciated that all previous embodiments of the present invention described herein may include a top fluid port (10) depending upon the application and the nature of the progressive dampened motion required.

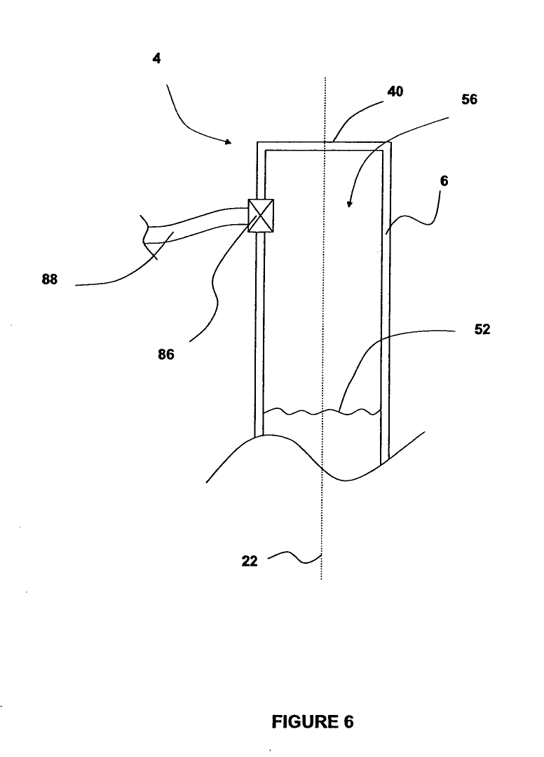

In all embodiments of the present invention described herein, it will be appreciated by those skilled in the art that the position at which the “hydraulic lock” occurs is highly influenced by the relative pressure of the gas contained within plunger (6) having been compressed by the liquid. In some instances it may be preferable to provide a mechanism for increasing the relative pressure of the gas contained within the distal end (4) of the plunger (6). One practical method of achieving this is shown in FIG. 6 whereby a gas port (86) or valve is included within the wall of plunger (6) so that a compressor or like device can be connected to the air port (86) by a hose (88) so as to introduce further gas to increase the internal gas pressure in the first chamber 8.

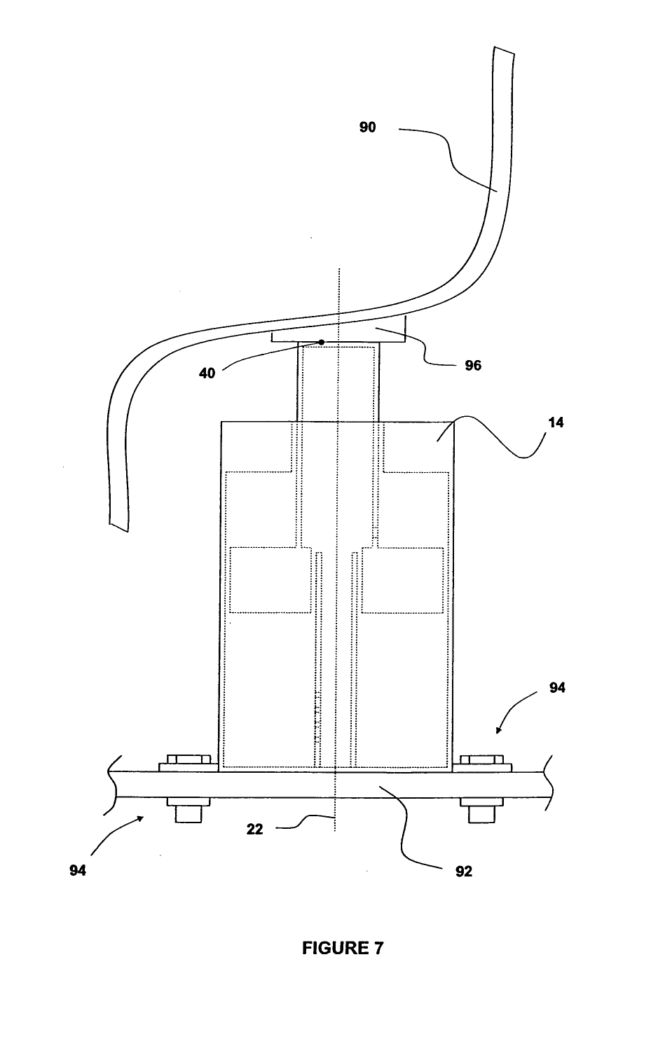

An example of the implementation of any one of the previously described embodiments, in accordance with the present invention, is shown in FIG. 7. It would be readily understood that the housing (14) may be positioned and fastened to a structure that is directly or indirectly affected by the particular loading conditions that are desired to be dampened. The component which is to be isolated from the applied loads is similarly fastened to the external wall (40) of the distal end (4) of the plunger (6). Although not limited to one particular application, or to any one particular embodiment described herein, an example may be seen with the housing (14) being firstly fastened, using any typical mechanical or adhesive fastening system (94), to the floor (92) of a bridge or operating room of a marine craft. In this instance, impact loadings from adverse sea conditions are transmitted to the floor of the marine craft from the hull. In order to safeguard the marine craft operator from impact loads while seated, a chair (90) or similar is positioned and fastened (by a suitable mechanical or adhesive coupling (96)) to the distal end (4) of the plunger (6). In such a configuration, the impact loads experienced by the marine craft operator while the marine craft is travelling across said sea states will be reduced and will afford to the chair (90) a progressively dampened motion rather than a direct transfer of the impact loads. A further example may be seen with the apparatus of the present invention being applied to passenger seats in a marine craft so that passengers may experience a smoother ride over rough seas.

It may be appreciated that numerous variations and modifications will suggest themselves to a person skilled in the relevant art, in addition to those already described, without departing from the basic inventive concepts. All such variations and modifications are to be considered within the scope of the present invention, the nature of which is to be determined from the foregoing description.

1-19. (canceled)

20. A suspension apparatus for providing a progressively dampened motion, said apparatus comprising:
a housing defining a first chamber and having a first end, said first chamber containing a volume of liquid;
a plunger defining a second chamber, said plunger movable within said housing and containing a volume of gas; and,
a fluid communication path between the first and second chambers, wherein movement of said plunger within said housing causes transfer of liquid between first and second chambers;
wherein said gas is compressed by flow of said liquid into said second chamber;
wherein said fluid communication path becomes progressively constricted as said plunger is moved toward said first end of said first chamber.

21. The suspension apparatus according to claim 20 wherein said fluid communication path comprises at least one aperture through which the liquid passes when flowing from the first chamber to the second chamber, and said at least one aperture becomes progressively obstructed as the plunger moves toward the first end.

22. The suspension apparatus according to claim 21 comprising a guide extending from said first end within said housing, wherein said plunger slides along said guide.

23. The suspension apparatus according to claim 22 wherein said guide defines a third chamber in fluid communication with said second chamber and wherein said at least one aperture is formed in said guide and provides fluid communication between said first chamber and said second chamber.

24. The suspension apparatus according to claim 23 comprising in a plurality of said apertures and wherein said apertures are progressively obstructed as said plunger moves toward said first end of said first chamber.

25. The suspension apparatus according to claim 22 wherein said at least one aperture comprises a gap between said plunger and said guide.

26. The suspension apparatus according to claim 25 wherein said gap comprises a space formed between an opening in the plunger and an outer surface of a the guide received in said opening.

27. The suspension apparatus according to claim 26 wherein said portion of said guide has a cross sectional perimeter which varies along a length of the guide.

28. The suspension apparatus according to claim 27 wherein the cross sectional perimeter of said guide increases along said length of the guide towards an end proximal to said first end.

29. A suspension apparatus for providing a progressively dampened motion, said apparatus comprising;
a housing defining a first chamber having a first end, said first chamber containing a volume of liquid;
a plunger defining a second chamber containing a volume of gas, said plunger movable within said housing; and,
a stem along which said plunger moves the stem defining a third chamber which is in fluid communication with said second chamber, said stem having at least one aperture permitting fluid communication between said first and third chambers whereby liquid is transferred between said second chamber via said third chamber so as to compress said gas and said at least one aperture becomes progressively obstructed when said plunger is moved toward said first end of said first chamber.

30. A suspension apparatus for providing a progressively dampened motion, said apparatus comprising;
a housing defining a first chamber having a first end, said first chamber containing a volume of liquid;
a plunger defining a second chamber containing a volume of gas, said plunger movable within said housing; and,
a stem along which said plunger moves, the stem and the plunger relatively configured to form a fluid flow path through which liquid flows from said first chamber into said second chamber to compress said gas when said plunger is moved towards said first end of the first chamber, the fluid flow path being progressively constricted by motion of the plunger towards said first end.

31. The suspension apparatus according to claim 30 wherein said stem extends from said first end and is tapered in a direction toward a distal end of said stem.

32. A suspension apparatus according to claim 31 wherein said stem defines a third chamber in fluid communication with said second chamber, said fluid communication path further providing fluid communication through at least one aperture, axially or radially spaced within said stem, to permit transfer of liquid from said first chamber to said second chamber.

33. The suspension apparatus according to claim 22 wherein the dimension of said at least one aperture is varies as said plunger moves toward said first end.

34. A suspension apparatus according to claim 33 wherein a base of said housing is rigidly mounted to a chassis or floor of a marine craft.

35. The suspension apparatus according to any one of claims 20 to 34 wherein at least one sealing means is provided within at least one aperture within said housing into which said plunger is slidingly engaged.

36. The suspension apparatus according to claim 20 comprising a valve capable connecting with a compressor or like device to enable an increase in pressure of said volume of gas.
